(19) United States
(12) Patent Application Publication
(10) Pub. No.: US 2024/0133414 A1
(43) Pub. Date: Apr. 25, 2024

(54) FASTENING MEMBER

(71) Applicants: KABUSHIKI KAISHA TOSHIBA, Tokyo (JP); TOSHIBA ENERGY SYSTEMS & SOLUTIONS CORPORATION, Kawasaki-shi Kanagawa (JP)

(72) Inventors: Shun OINUMA, Yokohama Kanagawa (JP); Yasutaka KAWADA, Kawasaki Kanagawa (JP); Takashi MIURA, Kawasaki Kanagawa (JP); Hidekazu MIYAJIMA, Shinagawa Tokyo (JP); Toru ABE, Yokohama Kanagawa (JP); Kazuki KURODA, Yokohama Kanagawa (JP)

(73) Assignees: KABUSHIKI KAISHA TOSHIBA, Tokyo (JP); TOSHIBA ENERGY SYSTEMS & SOLUTIONS CORPORATION, Kawasaki-shi Kanagawa (JP)

(21) Appl. No.: 18/400,375

(22) Filed: Dec. 29, 2023

Related U.S. Application Data
(63) Continuation of application No. PCT/JP2021/033768, filed on Sep. 14, 2021.

(51) Int. Cl. F16B 33/00

(52) U.S. Cl. CPC F16B 33/008

(57) ABSTRACT

A fastening member in an embodiment consists of a bolt and a nut. A hard layer made of a metal nitride is formed on a surface of a threaded portion of the bolt or a surface of a threaded portion of the nut.

### CROSS REFERENCE TO RELATED APPLICATIONS

This application is a continuation application of prior International Application No. PCT/JP2021/033768, filed Sep. 14, 2021; the entire contents of which are incorporated herein by reference.

### FIELD

Embodiments of the present invention relate to a fastening member.

### BACKGROUND

Examples of the power generation equipment installed in a thermal power plant include an apparatus that operates at high temperatures for a long period of time. Each component of this high-temperature apparatus is required to exhibit stable performance without deterioration over a long period of time.

During a periodic inspection of such a high-temperature apparatus, fastening members such as bolts and nuts are locked and cannot be disassembled in some cases. In this case, for example, the fastening members are removed by being hit or cut.

The process of removing such locked fastening members extends the inspection time. In addition, the inspection cost increases because new fastening members are required.

In the case of fastening at high temperatures, the following causes can be cited as the causes for locking of fastening members. The first cause is that the fastened state is maintained at high temperature and high load stress for a long period of time, and thereby the loosening agent applied to the surface of one fastening member reacts with the other fastening member to cause locking. The second cause is that high-temperature oxidation and corrosion occur on the attached surface of the fastening member and oxide scales grow, to thereby cause locking. The third cause is that the fastening members are diffusion-bonded to each other, to thereby cause locking.

In any of the above-described locking, the gap that originally exists between the fastening members disappears. Then, the higher the affinity of the locked surfaces after the gap disappears, the higher the static friction coefficient for sliding the locked surfaces. For example, sticking between the same members has a high affinity and a high static friction coefficient.

In conventional fastening members, a technique to prevent electrolytic corrosion between fastening members in contact with each other and a technique to prevent rust between fastening members in contact with each other have been studied. These techniques have been considered with environmental deterioration resistance at room temperature in mind.

As described above, the conventional fastening members have been designed to prevent deterioration caused by corrosion, assuming that the environment in which they are used is at a temperature around room temperature. Therefore, the above-described causes for locking in high-temperature usage environments and the like are not taken into consideration.

In addition, the fastening members used in high-temperature apparatuses reach temperatures exceeding 500° C., for example. In such high-temperature environments, in addition to the above-described causes for locking, deformation such as creep also occurs simultaneously. The fastening members to be used in high-temperature apparatuses are required to not deteriorate over a long period of time in such complex environments and to prevent locking.

### BRIEF DESCRIPTION OF THE DRAWINGS

FIG. 1 is a view illustrating a longitudinal cross section of a fastening member in an embodiment.

FIG. 2 is a view illustrating a longitudinal cross section of a state where members to be fastened are fastened by the fastening member in the embodiment.

FIG. 3 is a view illustrating a longitudinal cross section of the state where the members to be fastened are fastened by the fastening member in the embodiment.

FIG. 4 is a view illustrating a longitudinal cross section of the state where the members to be fastened are fastened by the fastening member in the embodiment.

FIG. 5 is a view illustrating steps of a manufacturing method of the fastening member in this embodiment.

### DETAILED DESCRIPTION

Hereinafter, embodiments of the present invention will be described in reference to the drawings.

In one embodiment, a fastening member in an embodiment consists of a male thread and a female thread. A hard layer made of a metal nitride is formed on a surface of a threaded portion of the male thread or a surface of a threaded portion of the female thread.

FIG. 1 is a view illustrating a longitudinal cross section of a fastening member 1 in the embodiment. Here, FIG. 1 illustrates a bolt 10, which is the fastening member 1.

The fastening member 1 consists of a bolt and a nut, or a bolt and a threaded hole into which the bolt is screwed. Here, the bolt functions as a male thread, and the nut and the threaded hole function as a female thread.

First, the bolt 10, which is the fastening member 1, is explained.

As illustrated in FIG. 1, the bolt 10 includes a head portion 11, a cylindrical portion 12, and a threaded portion 13.

A hard layer 20 is formed at least on the surface of the threaded portion 13. That is, the hard layer 20 is formed on the surface of the base material of the bolt 10 that forms the threaded portion 13.

Here, there is explained one example where the hard layer 20 is formed on a surface 12a of the cylindrical portion 12 and a rear surface (seat surface) 11a of the head portion 11 in addition to on the threaded portion 13.

The bolt 10 is made of ferritic heat-resistant steel, Ni-based superalloy, austenitic heat-resistant steel, or other materials. The reason why the bolt 10 is made of these materials is because they have an excellent high-temperature strength and have relatively little loosening at a fastened portion exposed to high temperatures.

Examples of the ferritic heat-resistant steel include 9-12Cr-Mo heat-resistant steel, Cr—Mo heat-resistant steel, Cr—Mo—V heat-resistant steel, and so on. Incidentally, the 9-12Cr-Mo heat-resistant steel means that it contains Cr in a range of 9 to 12 mass %.

Examples of the Ni-based superalloy include UNS N07718 (US standard (Japanese registered trademark: INCONEL718)), UNS N07520 (US standard), UNS N07001 (US standard), and so on.

Examples of the austenitic heat-resistant steel include AISI 304 (US Standard (Japanese Standard: SUS304)), AISI 316 (US Standard (Japanese Standard: SUS316)), AISI 310S (US Standard (Japanese Standard: SUS310)), and so on.

The hard layer 20 is made of a material different from that of the fastening member 1. Further, the hard layer 20 is made of a material that is inert at high temperature and has excellent oxidation resistance and wear resistance. Specifically, the hard layer 20 is made of a metal nitride, which is a compound of nitrogen and metal. The metal nitride is inert at high temperature and has excellent oxidation resistance. Further, the metal nitride is hard and has excellent wear resistance.

The hard layer 20 is preferably formed of a Ti-based nitride or a Cr-based nitride, which has excellent heat resistance, oxidation resistance, and wear resistance, among metal nitrides.

Examples of the Ti-based nitride include TiN, TiAlN, TiCN, and so on. Examples of the Cr-based nitride include CrN, CrAlN, and so on. Among the Ti-based nitrides and the Cr-based nitrides, TiAlN and CrN are more suitable for the hard layer 20.

The thickness of the hard layer 20 is preferably 2 μm to 10 μm. By setting the thickness of the hard layer 20 within this range, excellent locking resistance can be obtained. When the thickness of the hard layer 20 exceeds 10 the locking resistance can be obtained, but the operation time and cost for forming the hard layer 20 increase.

Here, the locking resistance mentioned here refers to the property that the fastening members do not stick to each other and can be loosened with a tool such as a normal spanner when removing the fastening members. The case where excellent locking resistance is obtained means that when removing the fastening members, the fastening members do not stick to each other and can be easily loosened with a tool such as a normal spanner, for example, with a loosening torque of 700 Nm or less.

When the loosening torque is 700 Nm or less, the fastening member can be normally removed with tools used at an inspection site. Incidentally, when the loosening torque exceeds 800 Nm, for example, the fastening member cannot be removed normally. In this case, the fastening member is removed by applying a blow to the fastening member, cutting the fastening member, or another means.

The hard layer 20 is formed by, for example, a physical vapor deposition method (PVD method). The hard layer 20 is formed in the shape of threads on the surfaces of the threads of the threaded portion 13. By forming the hard layer 20 by the PVD method, the hard layer 20 can be uniformly formed on the surface of the threaded portion 13. That is, by the PVD method, the hard layer 20 is formed to have a uniform thickness over the entire surfaces of the threads of the threaded portion 13.

Here, the PVD method is a method in which a substance to form the hard layer 20 is heated to a high temperature, vaporized, and adsorbed onto the bolt 10 to form a solid coating of the substance (hard layer 20) on the surface of the bolt 10.

The surface hardness of the hard layer 20 is preferably 1500 HV (Vickers hardness) or more. In this surface hardness range, the hard layer 20 has a sufficient hardness at the surface and obtains excellent wear resistance.

The oxidation rate on the surface of the hard layer 20 is preferably 1×10⁻⁶ mm/h or less. The oxidation mentioned here is assumed to be oxidation in a high-temperature air, and the oxidation rate represents a time variation in the amount of thickening by oxide scales formed on the surface of the hard layer 20. The method of measuring the oxidation rate is based on JIS Z2290 “General rules for high-temperature corrosion test of metallic materials”.

In this oxidation rate range, the hard layer 20 has excellent oxidation resistance, thereby making it possible to inhibit locking caused by the formation of oxide scale on the surface of the hard layer 20.

Here, the nut or a member to be fastened with a threaded hole formed therein, which is screwed onto the bolt 10, may be formed of the same material as that of the bolt described above, or may be formed of a material different from that of the bolt 10, for example. The material forming the bolt 10 and the material forming the fastening member to be fastened to the bolt 10 are each determined in consideration of mechanical strength.

The friction coefficient of the hard layer 20 is preferably 0.3 or less. The friction coefficient mentioned here is a dynamic friction coefficient obtained by a non-lubricated ball-on-disc test at room temperature. The method of measuring the friction coefficient is based on JIS R1613 “Testing method for wear resistance of fine ceramics by ball-on-disc method”.

In this friction coefficient range, the friction coefficient is small, so that the loosening torque when loosening the bolt can be kept low.

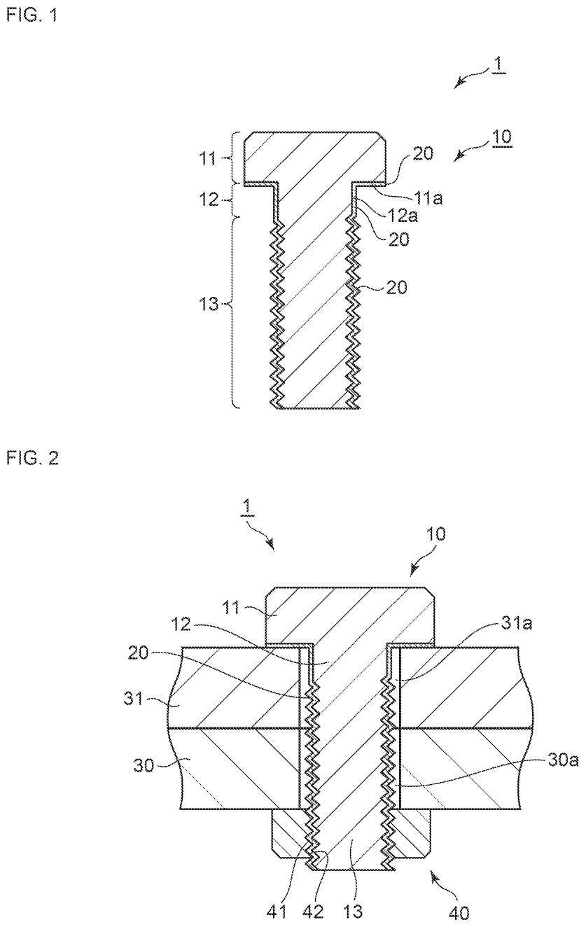

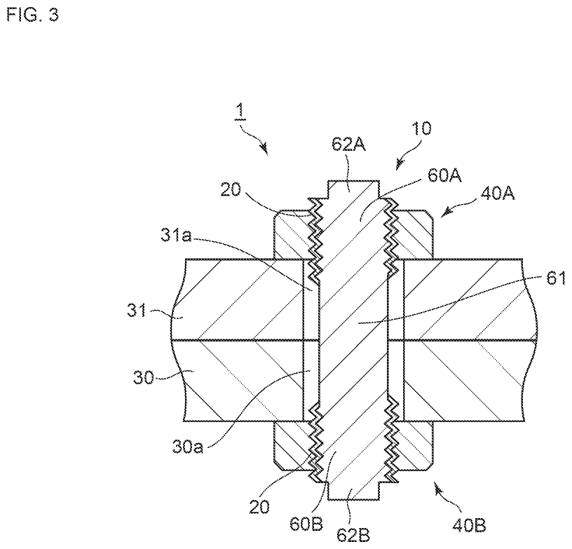

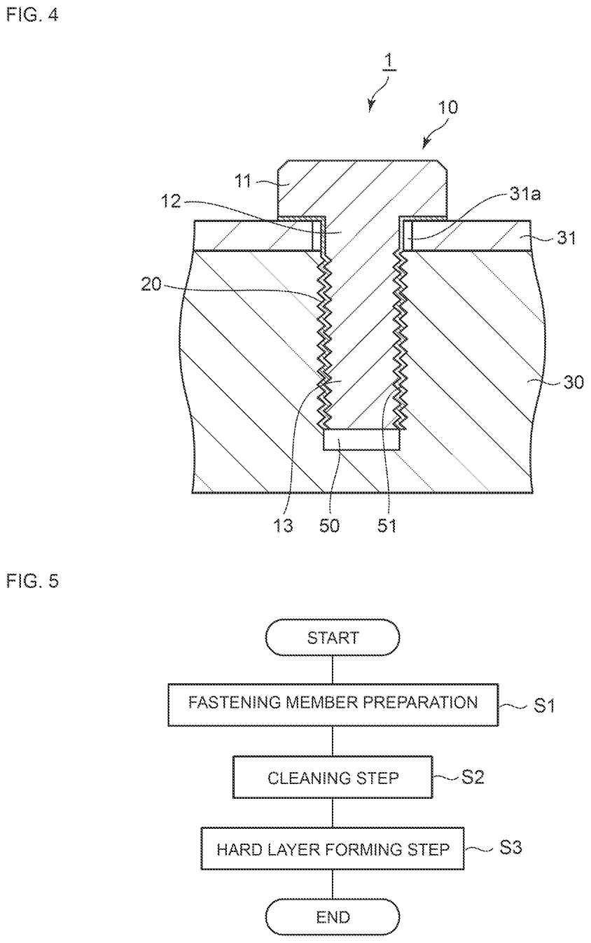

FIG. 2, FIG. 3, and FIG. 4 each are a view illustrating a longitudinal cross section of a state where members to be fastened 30 and 31 are fastened by the fastening member 1 in the embodiment.

Here, FIG. 2 and FIG. 3 illustrate a state where the bolt 10, which is the fastening member 1, and a nut 40, which is the fastening member 1, are fastened. FIG. 4 illustrates a state where the bolt 10, which is the fastening member 1, is fastened to a threaded hole 50 that is formed in the member to be fastened 30 and functions as the fastening member 1.

The fastening member 1 consists of the bolt 10 and the nut 40, or the bolt 10 and the threaded hole 50, for example. Incidentally, as the bolt 10, for example, there is a form illustrated in FIG. 1 in which the bolt 10 includes the head portion 11 on one end side and the threaded portion 13 that is screwed into the nut 40 on the other end side. Further, as the bolt 10, there is a form in which the bolt 10 includes threaded portions that are screwed into the nuts 40 at both ends, which will be explained later.

First, there is explained the case where the fastening member 1 consists of the bolt 10 and the nut 40, with reference to FIG. 2.

As illustrated in FIG. 2, the bolt 10 includes the head portion 11 on one end side and the threaded portion 13 on the other end side. Through holes 30a and 31a are formed in the members to be fastened 30 and 31, through which the cylindrical portion 12 and the threaded portion 13 of the bolt 10 are passed. The nut 40 is screwed onto the threaded portion 13 that has passed through the through holes 30a and 31a.

Here, the nut 40 may be directly screwed onto the threaded portion 13 on which the hard layer 20 is formed. Further, the nut 40 may be screwed onto the threaded portion 13 on which the hard layer 20 is formed with a loosening agent applied therebetween.

In the case of using the loosening agent, for example, the loosening agent is applied to the surface of the hard layer 20 on the threaded portion 13 that is to be screwed into the nut 40, and then the bolt 10 is screwed into the nut 40. Incidentally, the loosening agent may be applied to a threaded portion 42 formed on the inner circumference of a threaded hole 41 of the nut 40.

In the case of using the loosening agent, a layer made of the loosening agent is formed between the bolt 10 and the nut 40.

Here, the loosening agent is, for example, a paste-like coating material containing fine particles such as oxides and moisture. Examples of the loosening agent include Never-Seez Regular Grade (manufactured by Bostik), MOLYKOTE (manufactured by DuPont Toray Specialty Materials K.K.), Loctite (manufactured by HENKEL), and so on.

The loosening agent serves as a lubricant during initial fastening and as an anti-locking agent after high-temperature operation. Incidentally, the use of the loosening agent is not mandatory.

Here, fastening of the fastening member 1 is performed using a torque wrench or the like. The bolt 10 may be heated during fastening. At this time, for example, a bolt heater is installed in a center hole formed along the center axis of the bolt 10 to heat the bolt 10.

By heating the bolt 10 during fastening, the bolt 10 is thermally expanded and elongated in the axial direction. After fastening, heating by the bolt heater is stopped, and the bolt 10 cools down and contracts in the axial direction, resulting in that a high tightening force is obtained.

Further, when loosening the fastening member 1 after operating the fastening member 1 for a certain period of time, the same method as the method of fastening the fastening member 1 is applied. That is, removal of the fastening member 1 is performed using a tool such as a spanner. Further, when the bolt 10 is heated to be fastened, the bolt is heated by the bolt heater and then the fastening member 1 is loosened.

Next, there is explained the case where the fastening member 1 consists of a bolt and nuts 40A and 40B, with reference to FIG. 3.

As illustrated in FIG. 3, the bolt 10 includes threaded portions 60A and 60B, a cylindrical portion 61, and head portions 62A and 62B. The threaded portions 60A and 60B are provided at both ends of the bolt 10. The head portions 62A and 62B project axially outward from the end surfaces of the threaded portions 60A and 60B in the axial direction.

The head portions 62A and 62B function, for example, as an action portion when the bolt 10 is screwed into the nuts. Further, the head portions 62A and 62B function, for example, as a support portion for preventing turns of the bolt 10 when the bolt 10 is screwed into the nuts.

Incidentally, the cross-sectional shapes of the head portions 62A and 62B perpendicular to the axial direction of the bolt 10 are, for example, hexagonal. Regarding the size of the head portions 62A and 62B, they are formed to fit inside the outer edges of the threaded portions 60A and 60B.

On the surfaces of the threaded portions 60A and 60B of the bolt 10, the hard layer 20 is formed.

Incidentally, although there has been explained one example where a threaded portion is not provided on the cylindrical portion 61 here, a threaded portion may be provided on the cylindrical portion 61 of the bolt 10. That is, a threaded portion may be formed on the side surface of the bolt 10 in the axial direction.

The through holes 30a and 31a for passing the bolt 10 therethrough are formed in the members to be fastened 30 and 31. The bolt 10 is arranged to pass through the through holes 30a and 31a. Then, the threaded portion 60A is screwed into the nut 40A, and the threaded portion 60B is screwed into the nut 40B.

Incidentally, the nuts 40A and 40B may be directly screwed onto the threaded portions 60A and 60B on which the hard layer 20 is formed. Further, the nuts 40A and 40B may be screwed onto the threaded portions 60A and 60B on which the hard layer 20 is formed with a loosening agent applied therebetween.

Next, there is explained the case where the fastening member 1 consists of the bolt 10 and the threaded hole 50 formed in the member to be fastened 30.

As illustrated in FIG. 4, the through hole 31a for passing the cylindrical portion 12 and the threaded portion 13 of the bolt 10 therethrough is formed in the member to be fastened 31. The threaded hole 50 is formed in the member to be fastened 30. A threaded portion 51 is formed on the inner circumference of the threaded hole 50 to be screwed onto the threaded portion 13 on which the hard layer 20 is formed.

Here, the threaded portion 13 on which the hard layer 20 is formed may be directly screwed into the threaded hole 50 of the member to be fastened 30. Further, the threaded portion 13 on which the hard layer 20 is formed may be screwed into the threaded hole 50 of the member to be fastened 30 with a loosening agent applied therebetween.

The loosening agent may be applied to the surface of the hard layer 20 on the threaded portion 13 of the bolt 10, or may be applied to the surface of the threaded portion 51 of the threaded hole 50 in the member to be fastened 30. In the case of using the loosening agent, a layer made of the loosening agent is formed between the bolt 10 and the threaded hole 50. Incidentally, the use of the loosening agent is not mandatory.

Incidentally, even in the case where the fastening member 1 consists of the bolt and the threaded hole 50, the method of fastening the fastening member 1 and the method of loosening the fastening member 1 are the same as those in the case where the fastening member 1 consists of the bolt 10 and the nut 40 described above.

Here, the fastening member 1 in this embodiment is used, for example, for fastening of a power generation equipment that is installed in a thermal power plant and operates at high temperatures for a long period of time. The fastening member 1 is used, for example, for fastening of a power generation equipment whose temperature reaches a temperature exceeding 500° C. Therefore, the fastening member 1 also reaches a temperature exceeding 500° C.

In the power generation equipment, the fastening member 1 is used, for example, for fastening of a component member of a control valve that adjusts the flow rate of a high-temperature working fluid, fastening of a turbine member that increases in temperature, or for other objects. Incidentally, the apparatus in which the fastening member 1 is used is not particularly limited, and the fastening member 1 is used, for example, for fastening of a component member of a high-temperature apparatus whose temperature exceeds 500° C.

Here, as described previously, when the fastening members stick to each other, the gap that originally exists between the fastening members disappears. Then, the higher the affinity of the locked surfaces after the gap disappears, the higher the static friction coefficient for sliding the locked surfaces. For example, sticking between the same members has a high affinity and a high static friction coefficient.

In this embodiment, the hard layer 20 is formed on the surface of the threaded portion 13 of the bolt 10, and thereby, the hard layer 20 made of a different material, which is stable and does not deteriorate even at high temperatures, can be formed evenly and uniformly between the threaded portion 13 of the bolt 10 and the threaded portion 42 of the nut 40, or between the threaded portion 13 of the bolt 10 and the threaded hole 50 of the member to be fastened 30.

This makes it possible to provide the fastening member 1 capable of obtaining excellent locking resistance even when used in high-temperature environments. As described above, since the fastening member 1 in this embodiment has excellent locking resistance, it is possible to prevent the fastening members 1 from locking to each other even when the fastening members 1 used in high-temperature environments. This eliminates the need for a process to remove a locked fastening member, and does not cause an extension of the inspection period. Furthermore, there is no need to prepare a new fastening member, thus reducing the inspection costs.

Incidentally, although there has been explained one example where the hard layer is formed on the surface of the threaded portion 13 of the bolt 10, which is a male thread, the present invention is not limited to this configuration. For example, the hard layer 20 may be formed not on the surface of the threaded portion of the male thread but on the surface of a threaded portion of a female thread. That is, the hard layer 20 may be formed on either the surface of the threaded portion of the male thread or the surface of the threaded portion of the female thread.

### (Manufacturing Method of the Fastening Member 1)

Next, there is explained a manufacturing method of the fastening member 1 in this embodiment.

FIG. 5 is a view illustrating steps of the manufacturing method of the fastening member 1 in this embodiment.

Here, the method of forming the hard layer 20 on the surface of the threaded portion 13 of the bolt 10 is explained with reference to FIG. 5. The hard layer 20 is formed by the PVD method in the following step.

First, the bolt 10 on which the hard layer 20 is to be formed is prepared (fastening member preparation step: Step S1).

Then, the bolt 10 is cleaned to sufficiently remove dirt on the surface (cleaning step: Step S2).

Then, the bolt 10 is loaded into a chamber with a vacuum or reduced-pressure atmosphere. Then, while the bolt 10 rotating or orbiting, the substance to form the hard layer 20 is vaporized and adsorbed onto the surface of the bolt 10. Thereby, the hard layer is formed on the surface of the threaded portion 13 of the bolt 10 (hard layer forming step: Step S3).

At this time, the thickness of the hard layer 20 is adjusted by the time for which the vaporized substance is adsorbed onto the surface of the bolt 10. Incidentally, the bolt has a cylindrical shape and thus is suitable for forming the uniform hard layer 20 by the PVD method.

Incidentally, the step of forming the hard layer 20 on the surface of the threaded portion 42 of the nut 40 or on the surface of the threaded portion 51 of the threaded hole 50 formed in the member to be fastened 30 is also the same as the step of forming the hard layer 20 on the surface of the threaded portion 13 of the bolt 10 described above.

### (Fastening Test)

Next, a fastening test was conducted in order to demonstrate that the fastening member 1 in this embodiment has excellent locking resistance.

In the fastening test, as the fastening member 1, a bolt and a nut were used.

A bolt with a threaded portion having a diameter of 25.4 mm (1 inch) was used. Incidentally, as the nut, one including a threaded portion capable of being fastened to the threaded portion of the bolt was used.

In order to conduct the fastening test under various conditions, 20 sets of sample members each consisting of a bolt and a nut were prepared (Sample member 1 to Sample member 20).

The materials forming the sample members and the materials forming the hard layers are illustrated in Table 1. Further, Table 1 also illustrates the used loosening agents.

Incidentally, in Table 1, “None” of the hard layer material means that the bolt and the nut were screwed together without forming the hard layer on the surface of the threaded portion of the bolt. Further, “None” of the loosening agent means that the bolt and the nut were directly screwed together without using a loosening agent.

Incidentally, Sample member 1 to Sample member 10 correspond to the fastening member 1 in this embodiment, and Sample member 11 to Sample member 20 are comparative examples that are not within the scope of this embodiment.

TABLE 1

| | | | Hard | Surface | Oxidation | Dynamic | | Loosening |
|---|---|---|---|---|---|---|---|---|
| Sample | | | layer | hardness | rate ×10⁻⁶ | friction | Loosening | torque |
| member | Bolt material | Nut material | material | HV | mm/h | coefficient | agent | Nm |
| 1 | 11CrMo heat-resistant steel | 11CrMo heat-resistant steel | TiAlN | 2080 | 0.8 | 0.25 | Never-Seez | 660 |
| 2 | 11CrMo heat-resistant steel | 11CrMo heat-resistant steel | TiAlN | 2390 | 0.7 | 0.29 | MOLYKOTE | 580 |
| 3 | 11CrMo heat-resistant steel | 11CrMo heat-resistant steel | TiAlN | 2520 | 0.9 | 0.26 | Loctite | 500 |
| 4 | 11CrMo heat-resistant steel | 11CrMo heat-resistant steel | TiAlN | 2760 | 0.6 | 0.28 | None | 520 |
| 5 | UNS N07718 | 11CrMo heat-resistant steel | TiAlN | 2530 | 0.6 | 0.27 | Never-Seez | 500 |
| 6 | 11CrMo heat-resistant steel | 11CrMo heat-resistant steel | CrN | 1590 | 0.5 | 0.18 | Never-Seez | 680 |
| 7 | 11CrMo heat-resistant steel | 11CrMo heat-resistant steel | CrN | 2130 | 0.6 | 0.25 | MOLYKOTE | 630 |
| 8 | 11CrMo heat-resistant steel | 11CrMo heat-resistant steel | CrN | 1860 | 0.5 | 0.26 | Loctite | 580 |
| 9 | 11CrMo heat-resistant steel | 11CrMo heat-resistant steel | CrN | 1980 | 0.7 | 0.27 | None | 690 |
| 10 | UNS N07718 | 11CrMo heat-resistant steel | CrN | 2250 | 0.3 | 0.26 | Never-Seez | 480 |
| 11 | 11CrMo heat-resistant steel | 11CrMo heat-resistant steel | None | 240 | 15.2 | 0.32 | Never-Seez | 900 |
| 12 | 11CrMo heat-resistant steel | 11CrMo heat-resistant steel | None | 190 | 12.3 | 0.35 | MOLYKOTE | 920 |
| 13 | 11CrMo heat-resistant steel | 11CrMo heat-resistant steel | None | 200 | 14.6 | 0.34 | Loctite | 880 |
| 14 | 11CrMo heat-resistant steel | 11CrMo heat-resistant steel | None | 250 | 18.2 | 0.31 | None | 850 |
| 15 | UNS N07718 | 11CrMo heat-resistant steel | None | 430 | 1.5 | 0.36 | Never-Seez | 800 |
| 16 | 11CrMo heat-resistant steel | 11CrMo heat-resistant steel | TiC | 2060 | 2.5 | 0.31 | Never-Seez | 950 |
| 17 | 11CrMo heat-resistant steel | 11CrMo heat-resistant steel | TiC | 1560 | 2.6 | 0.27 | MOLYKOTE | 920 |
| 18 | 11CrMo heat-resistant steel | 11CrMo heat-resistant steel | TiC | 1680 | 6.3 | 0.26 | Loctite | 900 |
| 19 | 11CrMo heat-resistant steel | 11CrMo heat-resistant steel | TiC | 1870 | 3.7 | 0.31 | None | 880 |
| 20 | UNS N07718 | 11CrMo heat-resistant steel | TiC | 2210 | 1.2 | 0.3 | Never-Seez | 810 |

Here, the hard layer was formed based on the manufacturing method of the fastening member 1 described above. That is, the bolt and the nut were first cleaned. Then, the material to form each hard layer was vaporized to be adsorbed onto the surface of the threaded portion of the bolt by the PVD method. The thicknesses of the hard layers in all the sample members were set to 2 μm to 10 μm.

In the sample member using a loosening agent, the loosening agent was applied to the surface of the threaded portion of the bolt, and then the bolt was screwed into the nut.

In each of the sample members, the nut was held to screw the bolt into the nut using a torque wrench. The fastening torque at this time was set to 412 Nm. A torque wrench with a digital torque meter was used as the torque wrench.

Each of the sample members in which the bolt was screwed into the nut was subjected to an aging treatment at a temperature of 566° C. for 1000 hours. The aging treatment was performed in air.

After the aging treatment, each of the sample members was loosened. At this time, the nut was held to loosen the bolt using a torque wrench. Then, the loosening torque was measured with the torque wrench. The loosening torque value (Nm) of each of the sample members is illustrated in Table 1.

Further, Table 1 also illustrates the surface hardness of the hard layer, the oxidation rate on the surface of the hard layer, and the dynamic friction coefficient of the hard layer.

As illustrated in Table 1, the loosening torques in Sample member 1 to Sample member 10 are smaller than the loosening torques in Sample member 11 to Sample member 20. The loosening torques in Sample member 1 to Sample member 10 are all less than 700 Nm. Incidentally, the reason why the loosening torque is preferably 700 Nm or less is as described above.

That is, it reveals that in order to reduce the loosening torque, it is effective to use TiAlN, which is a Ti-based nitride, or CrN, which is a Cr-based nitride, as the material that forms the hard layer.

In Sample member 1 to Sample member 10, the effect of reducing loosening torque was obtained by providing a hard layer made of TiAlN or CrN for any of the materials (11Cr—Mo heat-resistant steel, INCONEL718) forming the sample members.

Further, the results in Sample member 15 and Sample member 20 reveal that even with specifications in which the sample member is made of a material that is stable even at high temperature, the effect of reducing loosening torque cannot be obtained when the hard layer is not provided or when the hard layer is made of TiC.

Further, in Sample member 1 to Sample member 10, the effect of reducing loosening torque was obtained even when no loosening agent was used. This is considered to be because the hard layer formed on the surface exhibited an effect equal to or greater than that of the loosening agent, which works to prevent contact between the fastening members.

The reason why even when no loosening agent was used in Sample member 1 to Sample member 10, the effect equal to or greater than that of the case where a loosening agent was applied was exhibited is considered to be due to the following factors. First, it is difficult to apply the loosening agent completely and uniformly to the surface of the fastening member. Second, the loosening agent may react with the fastening member and deteriorate at high temperature. In contrast, the hard layer is uniformly formed on the surface of the fastening member and is stable even at high temperature.

The results of the fastening test reveal that the fastening member 1 in this embodiment obtained excellent locking resistance even when used at temperature exceeding 500° C.

According to the above-explained embodiment, it is possible to obtain excellent locking resistance even when the fastening member 1 used in high-temperature environments.

While certain embodiments of the present invention have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A fastening member consisting of a male thread and a female thread, wherein
a hard layer made of a metal nitride is formed on a surface of a threaded portion of the male thread or a surface of a threaded portion of the female thread.

2. The fastening member according to claim 1, wherein
the metal nitride is made of a Ti-based nitride or a Cr-based nitride.

3. The fastening member according to claim 1, wherein
the fastening member is used at a temperature of 500° C. or more.

4. The fastening member according to claim 1, wherein
the fastening member is made of ferritic heat-resistant steel, Ni-based superalloy, or austenitic heat-resistant steel.

5. The fastening member according to claim 1, wherein
a surface hardness of the hard layer is 1500 HV or more.

6. The fastening member according to claim 1, wherein
an oxidation rate on a surface of the hard layer is 1×10⁻⁶ mm/h or less.

7. The fastening member according to claim 1, wherein
a dynamic friction coefficient of the hard layer, which is obtained by a non-lubricated ball-on-disc test at room temperature, is 0.3 or less.
